(19) United States
(12) Patent Application Publication
(10) Pub. No.: US 2004/0216148 A1
(43) Pub. Date: Oct. 28, 2004

(54) Service and support mechanism for delivering electronic customer support services

(76) Inventors: Philip J. Cootey, Boston, MA (US); James P. Byrne, Dublin (IE)

Correspondence Address: LACASSE & ASSOCIATES, LLC, 1725 DUKE STREET, SUITE 650, ALEXANDRIA, VA, 22314, US

(21) Appl. No.: 10/218,837

(22) Filed: Aug. 13, 2002

(51) Int. Cl. G06F 9/00; G06F 9/46

(52) U.S. Cl. 719/328

(57) ABSTRACT

An Internet-based customer request management software system for assisting customers to resolve service requests raised in projects is disclosed. In a preferred embodiment, the system comprises a server computer operatively connected to a network; at least one server program executing on the server computer comprising at least one software interface for sharing and manipulating project-related information and documents, and at least one software interface for receiving project-related service requests (SRs) from customers and linking at least a portion of the SRs to at least a portion of the project-related information.

### BACKGROUND OF THE INVENTION

The present invention relates in general to Internet-based project information management and customer request management (CRM) systems and in particular to a software system for providing interactive and cost-effective project management and customer request resolution service for project participants.

Traditional Internet-based CRM systems use a point-to-point model in which a single customer communicates with only one service representative to resolve an issue. Issues raised by customers are resolved one at a time and in complete isolation from any other issue that has been or is being resolved for the same customer. These characteristics of the point-to-point model make traditional customer service a slow process since information about related issues cannot be shared. Specifically, under the point-to-point model, one service representative may only have limited knowledge or access to the environment in which the issue arises. Moreover, the isolation of issues means that experiences obtained through solving one issue cannot be utilized to help solve other issues. Further more, little collaboration between representatives exist since different representatives usually work on isolated issues. It is quite possible that an issue is not worked on by the representative with the most relevant experience and that representative cannot share his knowledge with others, thereby reducing the cost-effectiveness of the point-to-point model.

A typical way to solve the above problem is to provide an account manager to coordinate the resolution of customer requests. This approach is of limited help since the account manager may not have full knowledge about the scope of an issue and may not be able to assign the most competent representative to resolve the issue.

Another problem associated with traditional CRM systems is that it is difficult for customers to gather needed product information related to their requests. Traditional CRM tools organize service requests and related content by agreement, company, site and contact. This is not very useful for customers since they typically organize their use of products through some form of a project structure. It is therefore nearly impossible for these customers to obtain a complete picture of all the needed product information at a project level.

Yet another problem associated with the point-to-point model is accessibility. The point-to-point models are limited to phone conversations and emails with the occasional online tracking service for customer requests. New technologies that we now use all the time (e.g. PDAs, Instant Messaging services) have not been integrated into these models. Moreover, information related to a request is usually kept in different formats such as word documents, powerpoint slides, emails, source code, etc. This makes it very difficult to access this information from different devices such as cell phones and PDAs.

### SUMMARY OF THE INVENTION

One aspect of the present invention comprises an Internet-based customer request management software system for assisting customers to resolve service requests raised in projects. This software system comprises software interfaces for sharing and manipulating project-related information and documents and software interfaces for receiving and resolving project-related service requests (SRs) from customers.

Another aspect of the present invention comprises an Internet-based customer request management software system that further comprises software interfaces to a discussion forum for members involved in a common project to share project-related information and discuss problems that have arisen in the project.

Yet another aspect of the present invention comprises an Internet-based customer request management software system wherein the software interfaces for receiving and resolving project-related service requests (SRs) from customers further comprises a first interface for creating and submitting SRs and a second interface for linking SRs to projects. SRs may be created and submitted by customers and resolved by project members. Project members can be either customer or staff providing technical support. Project members can also include anyone authorized under the project agreement, e.g. consultants, etc. To become a project member, a user's membership must be approved by the project administrator.

Yet another aspect of the present invention comprises an SR pool comprising data representing a plurality of SRs. Subject to restrictions which may be imposed by an administrator, an SR pool can contain SRs linking to any project within the same agreement, and a project member can draw from an SR pool to append to or create the project's SR collection linking together SR's from any project under their agreement. An SR collection can be created by either the submission of SRs from that project or by selecting SRs from the SR pool. An SR may be represented (typically by a pointer, index or object reference) in multiple SR pools.

Yet another aspect of the present invention comprises an Internet-based customer request management software system wherein the software interfaces for receiving and resolving project-related service requests (SRs) from project members further comprise an interface for modifying the content of SRs.

Yet another aspect of the present invention comprises an Internet-based customer request management software system wherein the software interfaces for receiving and resolving project-related service requests (SRs) from project members further comprise an interface for requesting service callback regarding SRs.

Yet another aspect of the present invention comprises an Internet-based customer request management software system wherein the software interfaces for receiving and resolving project-related service requests (SRs) from project members further comprise an interface for displaying all the action items associated with an SR.

Yet another aspect of the present invention comprises an Internet-based customer request management software system wherein the software interfaces for sharing and manipulating project-related information and documents further comprise a first interface for removing project documents and loading documents from a user's local computer to project documents, a second interface for sorting project documents, and a third interface for filtering project documents.

Yet another aspect of the present invention comprises an Internet-based customer request management software system wherein the software interfaces for sharing and manipulating project-related information and documents further comprise interfaces for viewing and updating products and product documentation used by a project.

Yet another aspect of the present invention comprises an Internet-based customer request management software system wherein the software interfaces for viewing and updating products used by a project further comprise a first interface for viewing the list of products, a second interface for viewing the details of a product, and a third interface for updating the information of a product. The product information being updated preferably includes product deployment information comprising information regarding product installation and configuration.

Yet another aspect of the present invention comprises an Internet-based customer request management software system wherein the software interfaces for viewing and updating products used by a project further comprise an interface for configuring test cases for a product.

Yet another aspect of the present invention comprises an Internet-based customer request management software system wherein the software interfaces for sharing and manipulating project-related information and documents further comprise interfaces for creating and viewing tasks related to a project.

Yet another aspect of the present invention comprises an Internet-based customer request management software system wherein the interfaces for creating and viewing tasks related a project further comprise a first interface for viewing, sorting, filtering or deleting tasks from the project's task list; a second interface for creating new tasks; and a third interface for modifying task contents.

Yet another aspect of the present invention comprises an Internet-based customer request management software system wherein the software interfaces for sharing and manipulating project-related information and documents further comprise interfaces for viewing project member information.

Yet another aspect of the present invention comprises an Internet-based customer request management software system wherein the software interfaces for sharing and manipulating project-related information and documents further comprise an interface for locating project-related information within the project hierarchy. Project-related information may be accessed using any suitable communications medium, such as the Internet, corporate intra-net or LAN.

Yet another aspect of the present invention comprises an Internet-based customer request management software system wherein the software interfaces for sharing and manipulating project-related information and documents further comprise an interface for managing bookmarks related to the project.

Yet another aspect of the present invention comprises a method for providing project-related customer support. The method comprises the steps of providing an interface for customers to create and submit project-related SRs; parsing the SR to obtain project information and sender's identity; linking the SR to its related projects.

Yet another aspect of the present invention comprises a method for creating a discussion forum within the project for project members to share project-related information.

Yet another aspect of the present invention comprises a method for providing project-related customer support further comprising the step of providing callbacks in response to customer's request to discuss details on an existing SR.

Yet another aspect of the present invention comprises a database containing project-related information. Information in the database is preferably categorized by association with a plurality of hierarchically-ordered projects. Information in the database preferably comprises profiles of each project; profiles of each customer involved in a project; lists of products used in each project; lists of SR's created by clients; and lists of action items associated with each SR.

Yet another aspect of the present invention comprises a document database wherein each service request further comprises the name of the company who owns the project, the contact of the client who creates the SR, the severity of the SR, the SR Type, and lists of product.

### BRIEF DESCRIPTION OF THE DRAWINGS

FIG. 1 schematically depicts the relationship between various components in the preferred embodiment.

FIG. 2 schematically depicts an interface for SR management used by the preferred embodiment.

FIG. 3 schematically depicts an interface for creating links between SRs and projects.

FIG. 4 schematically depicts an interface for updating products associated with the project.

FIG. 5 schematically depicts an interface for sharing project-related documents.

FIG. 6 schematically depicts an interface for tracking actions related to the project from a task list.

FIG. 7 schematically depicts a schema for a project area member data model.

FIG. 8 schematically depicts the relationship between SR collections, projects and SR pools.

### DESCRIPTION OF THE PREFERRED EMBODIMENTS

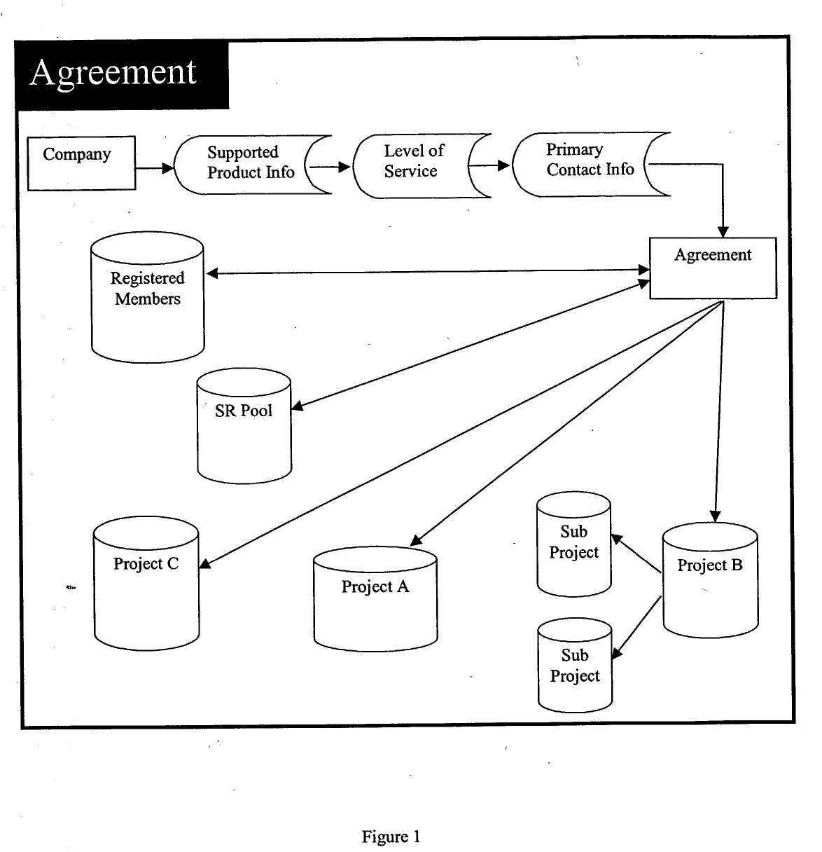

In one aspect, the present invention comprises a customer request management software system for customers and service representatives to solve project-related SRs in a collaborative fashion. The system permits customers to communicate with customer services and each other in a virtual project environment. The software system also assists in the exchange, organization and management of information within a project environment. In a preferred embodiment, a project may be created based on an agreement between the customer and the customer service provider. Multiple projects may be created under the same agreement, in accordance with the terms of the agreement. An agreement may place restrictions on the sharing of information within the software system. Preferably, project members cannot share information or service requests (SRs) with projects created under different agreements. The relationship between various component within a preferred embodiment of the software system is shown in FIG. 1.

One embodiment of the present invention comprises an Internet-based customer request management software system for assisting project members to resolve service requests raised in projects. The software system may comprise project manager software that allows project members to share and manipulate project-related information and documents and service request manager software that receives and tracks resolution of project-related service requests (SRs) from project members. The embodiment may also comprise a discussion forum for project members involved in the same project to share project-related information and discuss problems that have arisen in the project.

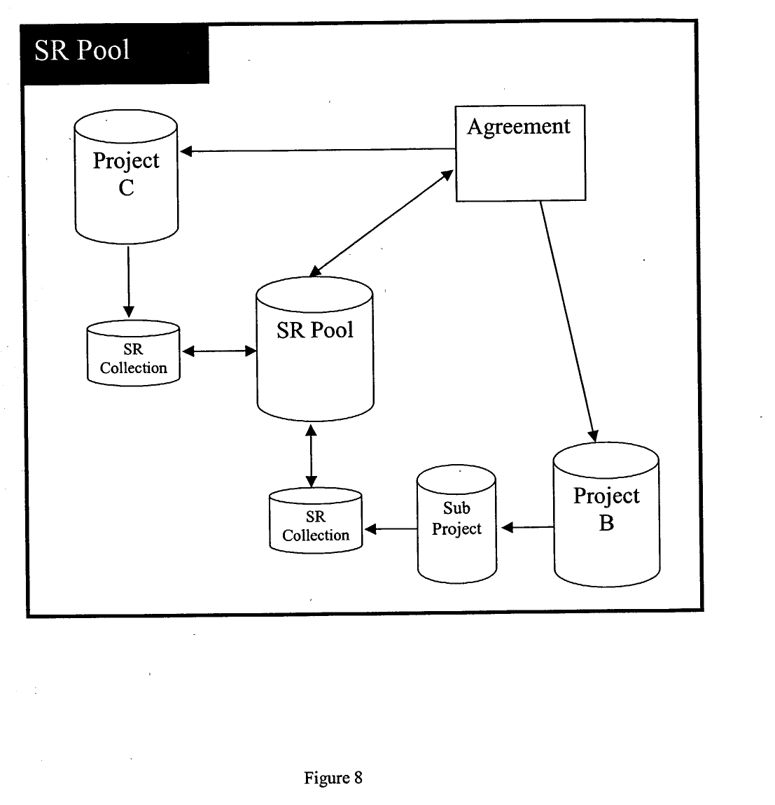

One preferred embodiment of the present invention comprises an SR management software system, a project management software system, and a discussion forum. In the SR management software system, project members are associated with the projects they participate in. Any customer can submit an SR, and SRs associated with a project are viewable by all the project members within the same project. An SR can be submitted by a customer, or it can be added to the project by the software system. A project may have more than one SR linked to it. An SR can be linked to more than one project. An SR has a single owner. The default owner of the SR is the customer who creates it. A project member can draw from an SR pool to append to or create the project's SR collection linking together SR's from any project under their agreement. An SR collection is created by either the submission of SRs from that project or by selecting SRs from the SR pool. An SR pool can contain SRs linking to projects within the same agreement. An SR may be contained in multiple SR pools. FIG. 8 schematically depicts the relationship between SR pools, SR collections and Projects.

The definitions below indicate the meaning of terms used in this document.

“Project administrator” means a person, typically a project member, responsible for the administration of a project. Typical duties of a project administrator include creating and setting up new projects, maintaining existing projects, assigning/removing members for a project, registering new users and assigning them to a project, removing documents from a project, and adding members who are not covered by the agreement to the discussion forum.

“Project member” means a person who is an agent of a customer or customer services and who can use the system in connection with a project. Typical duties and activities include adding documents to the project, creating/updating SRs, taking part in project discussions, adding SRs to project, updating product deployment information, adding/removing tasks, adding/removing bookmarks, and updating project details.

“Customer services provider” means an entity, typically an organization or individual, that provides support services for a customer pursuant to an agreement. Typical duties and activities include.

“Customer” means an entity, typically an organization or individual, that receives support services pursuant to an agreement.

“Agreement administrator” means a person responsible for the administration of an agreement.

“Agreement” means a contract between a customer and customer services provider which defines a level of service which will be provided by the customer services provider to the customer.

“Service request” means a request for service from a customer to the customer services provider. Examples include a request for technical information on a product, a request for feature information, or a bug or defect report.

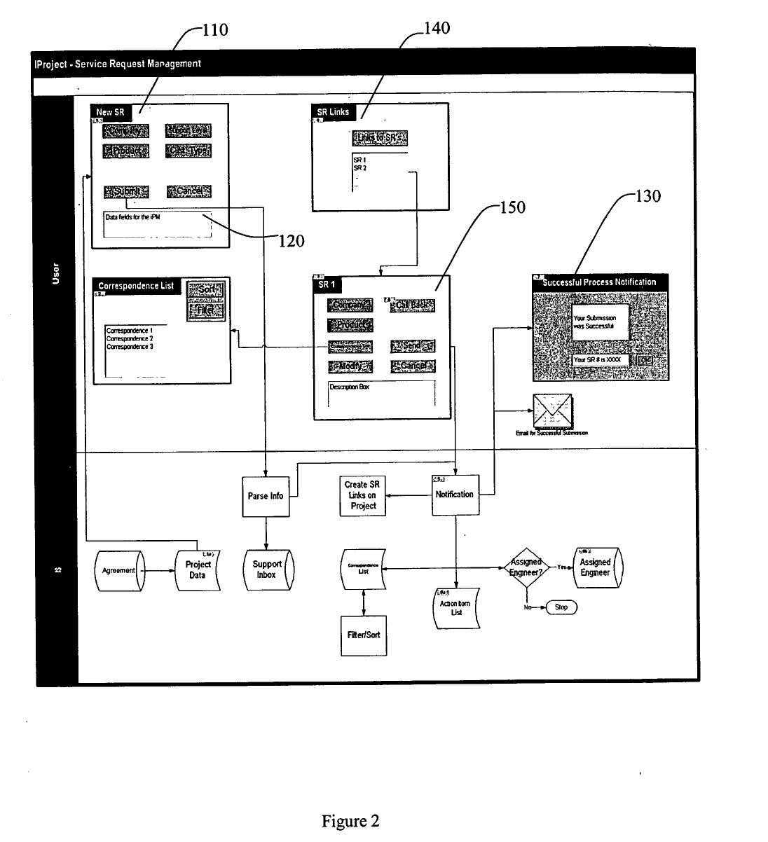

FIG. 2 shows an SR management scheme used by the preferred embodiment. A customer can create an SR through an interface. A example interface is the window labeled “New SR” 110 as shown in FIG. 2. The four buttons labeled “Company, “Support Level”, “Product”, “Cust. Type” correspond to system data files populated by the software system upon submission of company information, support level information product information, and customer type information, respectively.

The customer is required to provide data concerning the SR using the dialog box labeled “Data fields for the iPM” 120. The data preferably include the severity of the SR, the SR type and the list of products affected by the SR. Typical SR type may include “User Misunderstanding”, “Possible Product Bug”, “Documentation Question”, “Technical Question”, “General Request”, “Subject”, “Description”, and “Attachments”. The products affected by the SR may be selected from a product list. The product list may further comprise a primary product list and a secondary product list, wherein the secondary product list contains products that are being used by a product in the primary product list. The product list may be independent from the project, or specific to a project, depending on user preference.

The customer will be notified after the successful submission of an SR via email and a window served to the customer's web browser. The email notification will be send to the customer's email address with instructions on how to reply. The success window will preferably provide a summary of the SR submitted and an SR ID number, as shown in the window labeled “Successful Process Notification” 130 in FIG. 2. Before the notification is sent, the SR is parsed and project and customer information obtained for the SR. An SR link is created for every project affected by the SR. At the same time the notification is sent, an action item list for recording all the performed actions associated with the SR will be created and a “SR submitted” action is added to the list. An service engineer will be assigned to the SR and a correspondence list for the SR will be created to record the communications between the customer and the assigned engineer.

The process of resolving an SR preferably involves collaboration between the customer and project members as well as the sharing of information in the project or information from other projects or resources. A customer belonging to a project can access any SR that is associated with the project using an interface like the window labeled “SR Links” 140 in FIG. 2. By selection of an SR listed in the window, the customer is directed to another interface where information related to the selected SR is listed, like the window labeled “SRI” in FIG. 2 150.

In the preferred embodiment, if the customer is also the owner of the selected SR, he/she can also modify the content of the SR. Modifiable fields of the SR preferably include: Severity, SR Type, SR Status, Subject and Description. After the submission of the modified SR, both the SR Owner and the assigned engineer will be notified of the change. A notification of change will also appear in the action item list associated with the SR.

A customer preferably can also request a callback from a service engineer to discuss details on an existing SR. The callback request will be automatically added to the action item list and a callback notification is sent to the assigned engineer.

Every project generally has its own discussion forum typically accessible only by the project's members. The forum allows the project team to discuss issues of interest to the team in a common community area. Optionally, more accessible forums can also be created that are open to persons who are not project members.

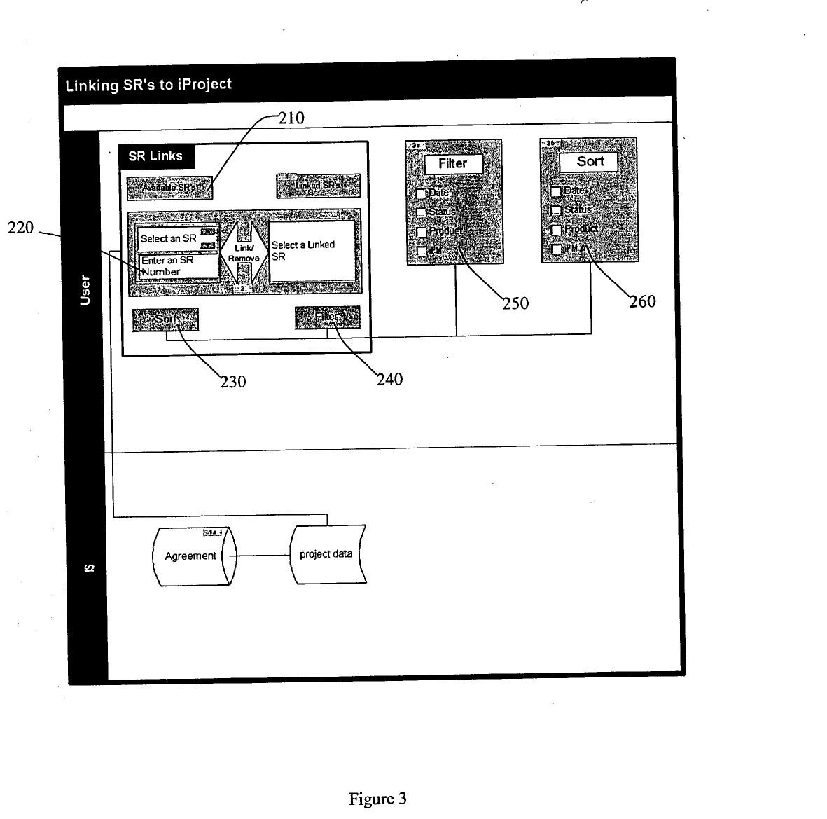

In the preferred embodiment, an SR is normally linked to a project automatically upon its submission. An SR can also be manually linked to other projects by a project administrator through an interface like the one shown in FIG. 3. (Note that an SR may not be linked to a project created based on a different agreement.) To link an SR to a project, the administrator can either select from a list of available SRs 210, or just type the SR ID in the text box labeled “Enter an SR number” 220. The list of SRs can be sorted and filtered using Sort button 230 an f filter button 240 and associated field selection check boxes 250, 260. Fields for sorting and filtering SRs preferably include “Date”, “Status”, “Product” and “Owner” (iPM). An SR can also be removed from a project using the same interface.

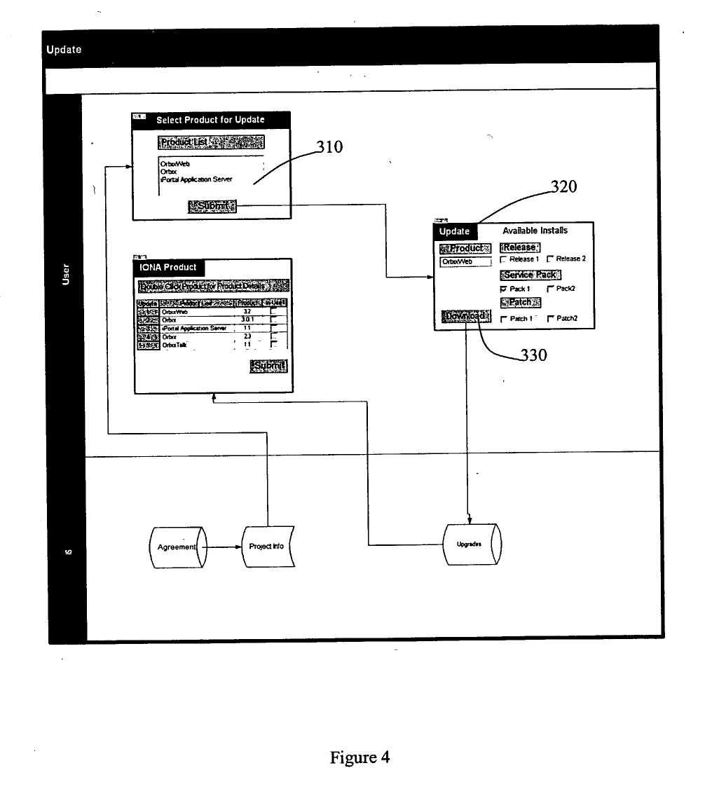

The preferred embodiment also comprises interfaces and systems to update products associated with the project. Product updates can be accomplished through the interface shown in FIG. 4. Using this interface, project members can download and install any release, service package, or patch of any product available to the customer. The customer chooses the product for update from the product list 310 and submit the request to the system. The system will provide a window like the one labeled “Update” 320 in FIG. 4 detailing the available releases, service packages and patches for download. The customer selects the desired release service package, or patch then clicks the download button 330 to download it.

After a successful download the update is appended to the product list as product available for use in the project. All the downloads, installations and configurations can be archived to provide a map of the customer's working environment. This map can be accessed by customer services to automatically configure a testing environment to build test cases from. All the test cases can also be archived and shared using a document sharing service.

The preferred embodiment of the present invention also comprises a document sharing service that enables project members to share documents related to the project. Project members can add, remove and download the documents. Examples of documents may include: operations guides, status reports, or project/architecture overviews.

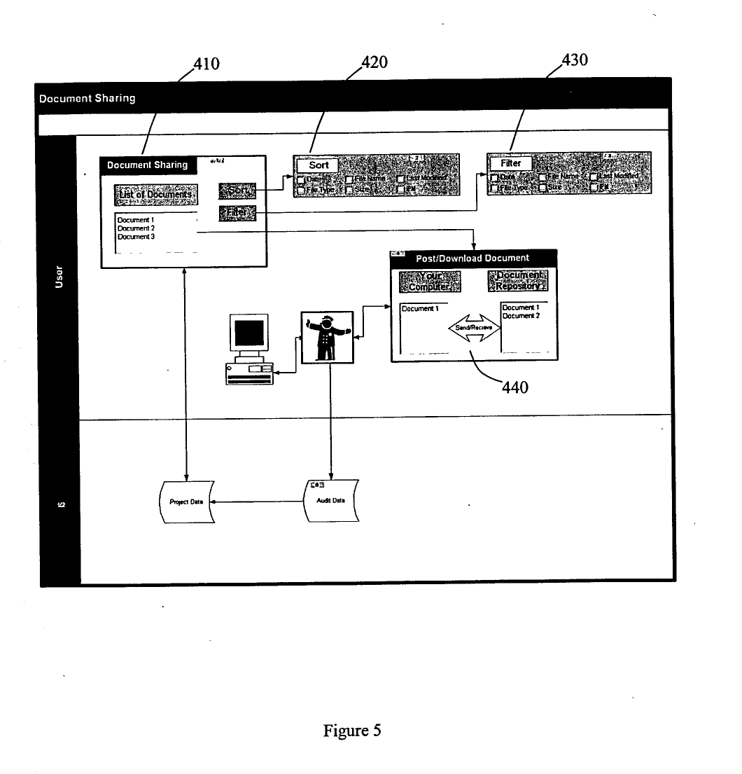

A typical interface for document sharing is shown in FIG. 5. A project member can select any document provided in the document list in the window labeled “Document Sharing” 410. These documents can be sorted and filtered based on certain fields described in the “sort” window 420 and the “filter” window 430 in FIG. 5.

A project member can also post a document to the project from the local filing system or download a selected document to the local file system using the window labeled “Post/Download Document” 440 shown in FIG. 5. Document can also be removed from the project. Document protection is preferably available on a per document basis. Document encryption may be available on a document-to-document basis.

Every time a document is added, downloaded or removed, the system preferably logs these details. Information to be logged preferably include name of the project member, date, document name, action (add, remove, download) and security information. Project members may opt to be notified when documents are added, downloaded or removed.

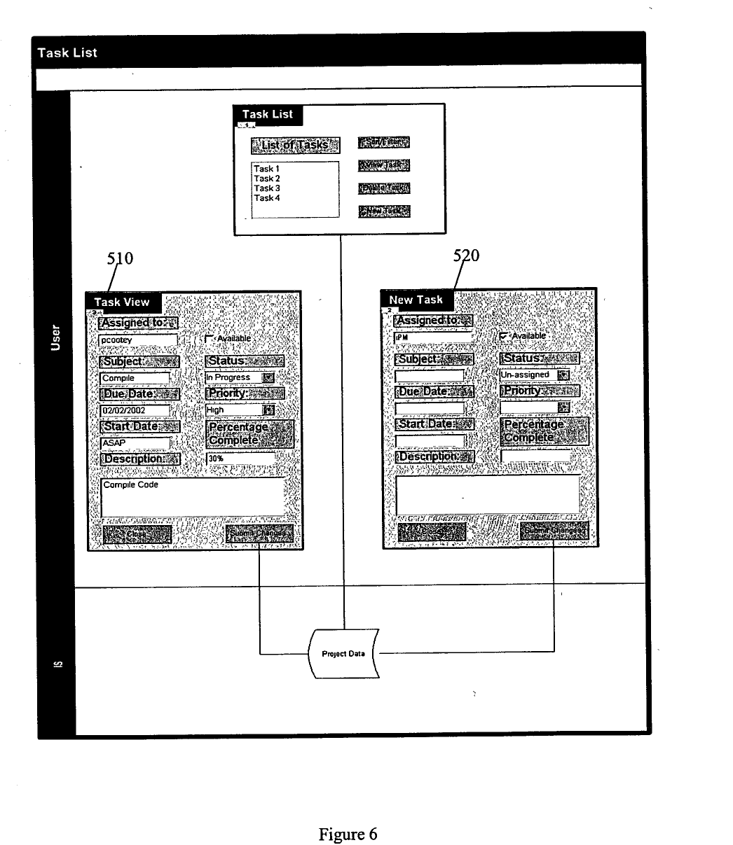

The present invention also comprises an interface for tracking actions related to the project from a task list. FIG. 6 shows a preferred embodiment of such an interface. The task list may be sorted and filtered using any task fields. Any project member is able to select a task to view and create a new task using the “Task View” window 510 and the “New Task” window 520, respectively.

When a new task is created, the project member who creates the task is the default owner of that task. Tasks are distinguished by availability, either being assigned or unassigned. A new task is unassigned by default.

In both the “New Task” 520 and the “Task View” 510 windows, the field “Assigned to” is used to indicate the ownership of the task; other descriptive fields for a task may include: subject, due date, start date, status, priority, percentage of completion, and description of the task. The task details may be modified by the task owner only. A task may be removed by the owner, or by the creator if it is unassigned.

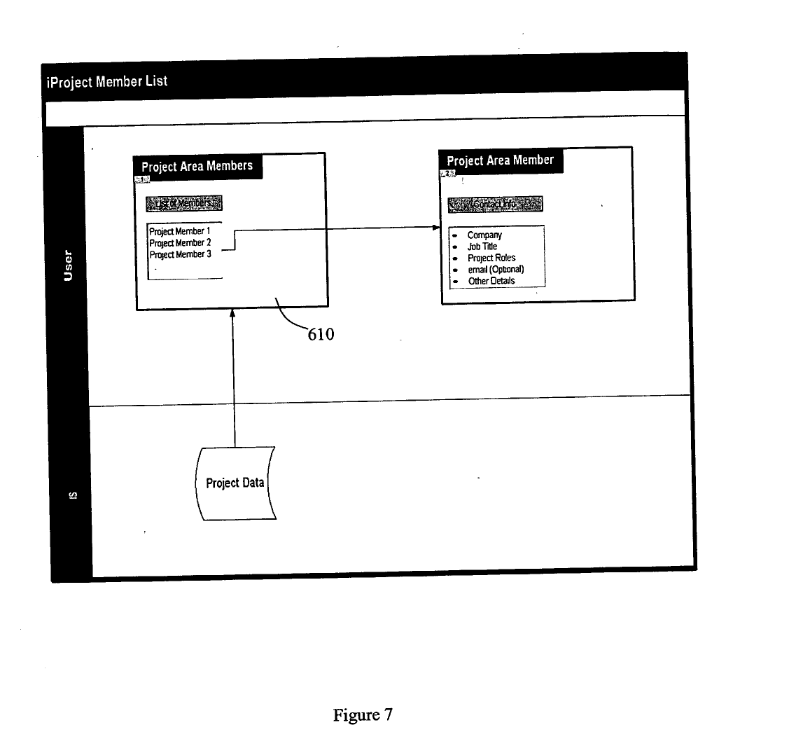

The present invention also comprises an interface for project members to view information about other project members. FIG. 7 shows such an interface. A project member can access contact information about another by selecting a project member from the list of members in the window labeled “Project Area Members” 610. The contact information may include: user name, project roles, job title, mailing address, email address, and company information.

The preferred embodiment may also include an interface of a document locator for customers or project members to search for documents within the project hierarchy on the Internet. The keyword entered by the project member may be automatically populated with project information in order to narrow the scope of the search. For example, if the project member enters key word “IDL” in the search field and OrbixWeb was the only product being used by the project, then the locator will only search OrbixWeb IDL articles.

The preferred embodiment also comprises an interface that allows project members to manage bookmarks relevant to the project itself.

The present invention also comprises an interface for project members to customize certain elements of their project environment and speeding up the process of SR resolution. Throughout the life-cycle of the project, project details will change. The existence of this interface facilitates the need for being able to change project details as work on the project progresses.

The interface for changing project details may comprise an interface to view and edit project details such as name, description and status. Any change in project status may be recorded. Typical values for project status include: Development, Archived, testing, or Deployment. Other local project status attributes can also be created by project administrators.

In one embodiment, projects are arranged in a hierarchical structure. A project member must register himself into the system and after completing a registration process the project member is given access to a root project. The root project is created based on an agreement between the customer and the customer service provider, as indicated before. The first root project is created by the system using default settings established when the agreement is created. It is ready to run without any immediate need to setup.

New projects may also be created from within root projects. This new project will also link back to the same agreement. A root project is unrelated to any other projects except those contained within it. A sub-project may be created from within another project based on the same agreement. A project hierarchy is created by creating sub-projects.

The content of project details may also comprise information about the products used by the project. In the preferred embodiment, an interface is provided for project members to view a list of installed products for the project. The interface also allows project members to indicate whether a product in the list is in use. This then allows the system to filter the product listings so that only products that are in use are presented to the project member in the SR management and product update interfaces. When a project is created all products in the product list are assumed to be in use.

The interface also allows view and edit product details. A product detail window is available for viewing the details of a product. The project member can access details by drilling down into the product from any of the three product interfaces: Installed Product, Agreement Product, or 3^{rd} Party Product. Information about a product preferably includes: Serial Number, Ship RequestID, Product Release, Version, Part Number, Date Shipped, OS product is installed on, URL's to product pages, and a free text note field to comment in. Information in the text note field preferably includes: an identifier of the machine the product is installed on, and URL's for product information pages. Information entered into the note field is seen only from the project into which it was entered. The interface may also allow the project administrator to add and remove project members belonging to a project.

The interfaces and software within the project member request management software system can be realized using a variety of programming tools such as the J2EE suite.

What is claimed is:

1. A software system for assisting customers to resolve service requests for projects, comprising:
a server computer operatively connected to a network;
at least one server program executing on the server computer comprising at least one software interface for sharing and manipulating project-related information and documents and at least one software interface for receiving project-related service requests (SRs) from customers and linking at least a portion of the SRs to at least a portion of the project-related information.

2. The software system of claim 1, further comprising:
at least one software interface for managing a discussion forum for project members involved in a project to share project-related information.

3. The software system of claim 1, wherein the at least one software interface for receiving project-related service requests (SRs) from customers further comprises:
a first interface for creating and submitting SRs; and
a second interface for linking SRs to projects.

4. The software system of claim 1, wherein:
the at least one software interface for receiving project-related service requests (SRs) from customers further comprises an interface for modifying the content of SRs.

5. The software system of claim 1, wherein:
the at least one software interface for receiving project-related service requests (SRs) from customers further comprises an interface for requesting service callbacks regarding SRs.

6. The software system of claim 1, wherein:
the at least one software interface for receiving project-related service requests (SRs) from customers further comprises an interface for displaying the action items associated with an SR.

7. The software system of claim 1, wherein the at least one software interface for sharing and manipulating project-related information and documents further comprises:
a first interface for removing project documents and loading documents from user's local computer to project documents;
a second interface for sorting project documents; and
a third interface for filtering project documents.

8. The software system of claim 1, wherein:
the at least one software interface for sharing and manipulating project-related information and documents further comprises at least one interface for viewing and updating products used by a project.

9. The software system of claim 8, wherein the at least one software interface for viewing and updating products used by a project further comprise:
a first interface for viewing a list of products; and
a second interface for viewing details of a product.

10 The software system of claim 8, wherein the at least one software interface for viewing and updating products used by a project further comprises an interface for configuring test cases for a product.

11. The software system of claim 1, wherein the at least one software interface for sharing and manipulating project-related information and documents further comprises at least one interface for creating tasks related to a project and at least one interface for viewing tasks related to a project.

12. The software system of claim 11, wherein the at least one interface for creating and viewing tasks related a project further comprises:
at least one interface for viewing, sorting, filtering, and deleting tasks from the project's task list;
at least one interface for modifying task contents.

13. The software system of claim 1, wherein the at least one software interface for sharing and manipulating project-related information and documents further comprise at least one interface for viewing project member information.

14. The customer request management software system of claim 1, wherein the at least one software interface for sharing and manipulating project-related information and documents further comprises an interface for locating project-related information over the Internet.

15. The customer request management software system of claim 7, wherein the at least one software interface for sharing and manipulating project-related information and documents further comprises an interface for managing bookmarks related to the project.

16. A method for providing project-related customer support, comprising the steps of:
providing an interface for customers to submit project-related service requests (SRs);
receiving an SR via the interface;
parsing the SR to obtain project information and sender's identity;
linking the SR to a project; and
creating a discussion forum for customers to share project-related information.

17. A document database containing a plurality of documents wherein the plurality of documents are categorized according to a plurality of hierarchically-ordered projects, said plurality of documents comprising:
a profile of a project;
a profile of a customer involved in the project;
a list of products used in the project;
a list of at least one service request (SR) submitted by an agent of the customer; and
a list of at least one action item associated with the at least one SR.

18. The document database of claim 17 wherein the at least one service request further comprises:
an identifier of an agreement;
contact information for the agent that submitted the SR;
the severity of the SR; and
the SR Type.
